(19) United States
(12) Patent Application Publication
(10) Pub. No.: US 2024/0028381 A1
(43) Pub. Date: Jan. 25, 2024

(54) VIRTUAL I/O DEVICE MANAGEMENT

(71) Applicant: Intel Corporation, Santa Clara, CA (US)

(72) Inventors: Shaopeng He, Shanghai (CN); Yadong Li, Portland, OR (US); Anjali Singhai Jain, Portland, OR (US); Eliel Louzoun, Jerusalem (IL); Israel Ben-Shahar, Jerusalem (IL); Brad A. Burres, Newton, MA (US); Bartosz Pawlowski, Gdansk (PL); Anton Nadezhdin, Gdansk (PL); Rashmi Hanagal Nagabhushana, Bangalore (IN); Rupin H. Vakharwala, Hillsboro, OR (US)

(73) Assignee: Intel Corporation, Santa Clara, CA (US)

(21) Appl. No.: 18/477,200

(22) Filed: Sep. 28, 2023

(30) Foreign Application Priority Data
Sep. 13, 2023 (WO) PCT/CN2023/118655

(51) Int. Cl. G06F 9/455

(52) U.S. Cl. CPC G06F 9/45558; G06F 2009/4557; G06F 2009/45595; G06F 2009/45579

(57) ABSTRACT

A network interface device executes an input/output (I/O) virtualization manager to identify a virtual device defined to include resources of a particular virtual functions in a plurality of virtual functions associated with a physical function of a device. An operation is identified to be performed between the virtual device and a system image hosted by a host system coupled to the network interface device. The network interface device emulates the virtual device in the operation using the I/O virtualization manager.

### CROSS-REFERENCE TO RELATED APPLICATION

This application claims the benefit of priority under 35 U.S.C. § 119(e) to Patent Cooperation Treaty (PCT) International Application No. PCT/CN2023/118655, filed Sep. 13, 2023, which is hereby incorporated by reference in its entirety.

### FIELD

The present disclosure relates in general to the field of distributed computing systems, and more specifically, to I/O virtualization.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Some platforms make use of I/O virtualization in order to improve datacenter performance. Single Root I/O Virtualization (SR-IOV) and Sharing specification, version 1.0 (2007) by the Peripheral Component Interconnect (PCI) Special Interest Group (PCI-SIG), provided hardware-assisted high performance I/O virtualization and sharing of PCI Express devices. Intel® Scalable IOV (SIOV) and Application Defined Infrastructure (ADI) are additional input/output (I/O) virtualization specifications that may serve to markedly expands current Peripheral Component Interconnect Express (PCIe) device number limitations to increase a number of containers or services that can utilize a PCIe device.

### BRIEF DESCRIPTION OF THE DRAWINGS

FIG. 1 illustrates a block diagram of components of a datacenter in accordance with certain embodiments.

FIG. 2 is a simplified block diagram of an example system implementing I/O virtualization.

FIG. 3 is a simplified block diagram illustrating an example computing system.

FIG. 4 is a simplified block diagram illustrating an example computing system including an enhanced network interface device.

FIG. 5A is a simplified block diagram illustrating an example SR-IOV capable device.

FIG. 5B is a simplified block diagram illustrating an example virtual I/O device definition.

FIG. 6 is a flow diagram illustrating an example of allocating virtual devices to an application or other process.

FIG. 7 is a flow diagram illustrating example use of an enhanced network interface device to perform I/O virtualization of a virtual function.

FIG. 8 illustrates a block diagram of an example processor device in accordance with certain embodiments.

Like reference numbers and designations in the various drawings indicate like elements.

### DETAILED DESCRIPTION

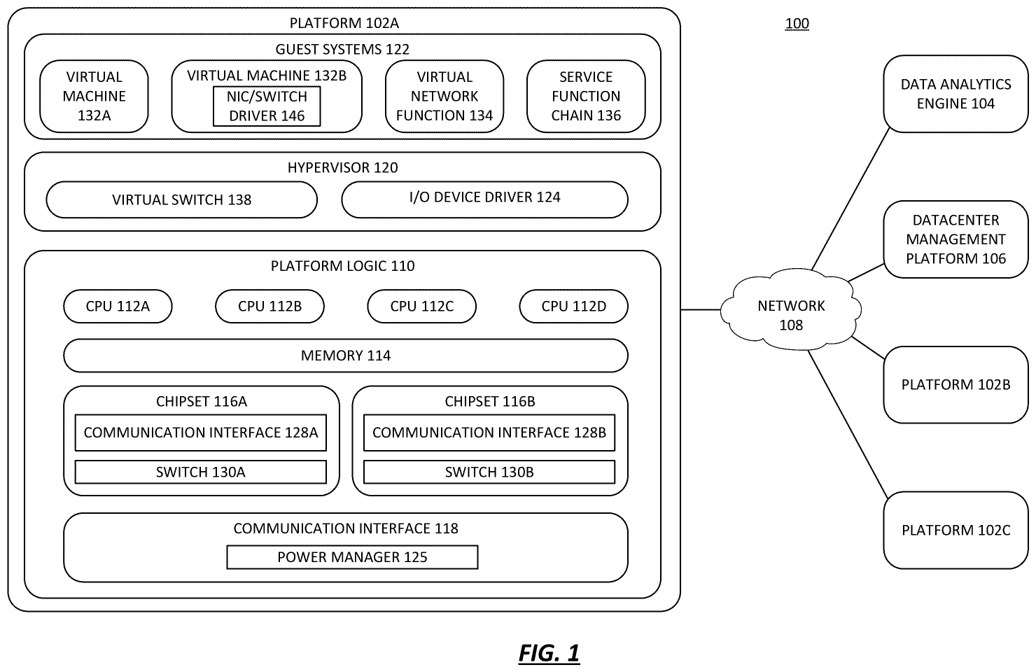

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

A platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the respective CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform. Further implementations may be supported, such as set forth above, for enhanced I/O virtualization. A host operating system may identify conditions and configurations of a system and determine that features (e.g., SIOV-based virtualization of SR-IOV-based devices) may be enabled or disabled and may utilize corresponding application programming interfaces (APIs) to send and receive information pertaining to such enabling or disabling, among other example features.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports). In some implementations, I/O virtualization may be supported within the system and utilize the techniques described in more detail below. I/O devices may support I/O virtualization based on SR-IOV, SIOV, among other example techniques and technologies.

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller, a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

Single Root I/O Virtualization (SR-IOV) is a PCI-SIG defined specification for hardware-assisted I/O virtualization that defines a standard way for partitioning endpoint devices for direct sharing across multiple VMs or containers. An SR-IOV capable endpoint device provides a Physical Function (PF) and multiple Virtual Functions (VFs). The PF of a device in SR-IOV provides resource management for the device and is managed by a host driver running in the host operating system (OS). A provided VF can be assigned to a VM or container for direct access. SR-IOV-capable devices may provide high performance I/O, including I/O devices such as network and storage controller devices as well as programmable or reconfigurable devices such as GPUs, FPGAs, and other accelerators, among other examples.

Scalable IOV (SIOV) also seeks to define an approach for the virtualization of I/O, for instance, within a data center. SIOV provides hardware-assisted I/O virtualization that enables a higher degree of scalability and performance in the sharing of I/O devices across isolated domains (e.g., VMs and containers). In SIOV, flexible composition of virtual devices for device sharing is enabled. Accesses between a VM and a virtual device are defined in SIOV as either a “direct path” access or an “intercepted path” access. Direct-path operations on the virtual device are mapped directly to the underlying device hardware for performance, while intercepted-path operations are emulated at least partially in software by a Virtual Device Composition Module (VDCM) to enable this greater flexibility in I/O virtualization. Which operations and accesses are processed as intercepted path versus direct path may vary depending on the device implementation and application. For instance, slow-path operations (e.g., initialization, control, configuration, management, QoS, error processing, and reset) are treated as intercepted-path accesses and fast-path operations (e.g., work submission and work completion processing) are treated as direct-path accesses, among other examples.

Similar to SR-IOV, resources of a given physical device may be mapped to individual VMs. In SIOV, a more customizable and granular approach is adopted, with SIOV enabling the flexible definition of virtual devices (VDEV) that may be mapped to a respective VM. High performance I/O devices may include a large number of command/completion interfaces for efficient multiplexing/demultiplexing of I/O. SIOV platforms may enable the assignment of such interfaces to isolated domains at a fine granularity. An SIOV architecture defines the granularity of sharing of a device or device resource as an “Assignable Device Interface” (ADI). Each ADI instance on the device may encompass the set of resources on the device that are allocated by software to support the direct-path operations for a virtual device. For instance, resources on a device associated with work submission, execution, and completion operations may implement device backend resources (e.g., command/status registers, on-device queues, references to in-memory queues, local memory on the device, or any other device-specific internal constructs). An ADI may identify a set (e.g., all or a subset of the total device resources, or even a combination of resources of two or more discrete devices) of device backend resources that are allocated, configured, and organized as an isolated unit, forming the unit of device sharing. The type and number of backend resources grouped to compose an ADI may be device specific. Each SIOV ADI on a device function may use the same PCIe Requester ID (Bus/Device/Function (BDF) number) corresponding to the device's PCIe Function. Process Address Space Identifiers (PASID) may be used to distinguish upstream memory transactions performed for different ADIs and to convey the address space targeted by the transaction.

ADIs form the unit of assignment and isolation for devices and are composed by software to form virtual devices (VDEVs). A Virtual Device Composition Module (VDCM) is responsible for managing virtual device instances. For instance, for direct-path accesses, a VMM may map the direct-path accesses from the guest directly onto the provisioned ADIs for the VDEV. For intercepted-path accesses, the VMM identifies the intercepted-path accesses from the guest and forwards them to VDCM for emulation. VDCM emulates the intercepted accesses to the VDEV. In some cases, the VDCM may access the underlying physical device corresponding to the ADI (e.g., to read a corresponding device register, identify ADI status, configure the ADI's PASID, etc.). Virtual device composition, among other advantages, enables increased sharing scalability and flexibility at lower hardware cost and complexity. SIOV utilizes software to define and share device resources with different address domains using different VDEV abstractions. For example, application processes may access a device using system calls and VMs may access a device using virtual device interfaces. Virtual device composition can also enable dynamic mapping of VDEVs to device resources, allowing a VMM to over-provision device resources to VMs. For instance, the resources of one or multiple physical devices may be mapped to a given VDEV. VDEVs may thus be defined to achieve particular goals of the system. As an example, in a data center with various physical machines containing different generations (e.g., versions) of the same I/O device, VDEVs may be defined to present the same VDEV capabilities irrespective of the different generations of physical I/O devices used in the VDEV definitions. Such a solution may allow the same guest OS image with a particular VDEV driver to be deployed or migrated to various combinations or deployments of physical machines.

During operation, upstream memory requests from all ADIs (within respective VDEV mapped to various VMs or containers) may be tagged with the Requester ID of the device (or device function) hosting the ADIs. Requests from different ADIs of the device function may be distinguished using a Process Address Space Identifier (PASID). The Requester ID and/or the PASID may be used to identify (e.g., in a TLP prefix) the address space associated with the request. Accordingly, when assigning an ADI to an address domain (e.g., VM, container, or process), the ADI may be configured with a unique PASID of the address domain and its memory requests may be tagged with the PASID value (e.g., in a PASID TLP Prefix).

As introduced above, in SIOV, a VDEV may serve as the abstraction through which a shared physical device is exposed to guest software. In some implementations, a VDEV may be exposed to a guest OS as a virtual PCI Express device. A VDEV may be defined to possess virtual resources such as virtual Requester ID, virtual configuration space registers, virtual memory BARs, virtual MSI-X table, etc. Each VDEV may be mapped to or formed from one or more ADIs (corresponding to various devices or device functions). The ADIs backing a VDEV may belong to the same physical function or allocated across multiple functions (e.g., to support device fault tolerance or load balancing).

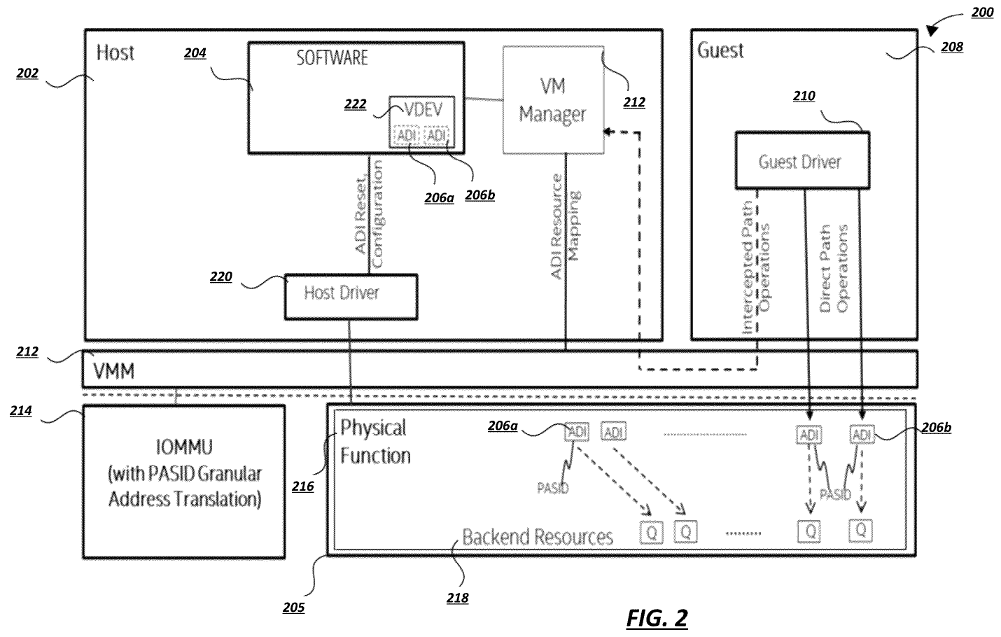

FIG. 2 is a simplified block diagram 200 illustrating a traditional implementation of an example operating environment 200 that supports the SIOV architecture to virtualize one or more devices (e.g., 205) such as component devices on a given computing platform or other packages, such as accelerators, I/O devices, network processing devices, etc. In this example, the operating environment may include a host OS 202, a guest OS 208, a VMM 212, an input/output memory management unit (IOMMU) 214, and one or more devices (e.g., 205) possessing I/O resources capable of being virtualized (e.g., based on SR-IOV or SIOV, etc.). Host OS 202, guest OS 208, and/or VMM 212 may execute on the host hardware 104. Host OS 202 may include a host driver 220 and guest OS 208 may include a guest driver 210.

As shown, in conventional embodiments of SIOV environments, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 205 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 205 that are allocated, configured, and organized as an isolated unit, forming the unit of device sharing of the device 205. The type and number of backend resources 218 grouped to compose a given ADI 206a, 206b, may be specific to the device 205. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 205 is a network controller, the ADIs 206a-206b may provide backend resources 218 that include transmit queues and receive queues associated with a virtual switch interface. As another example, if the device 205 is a storage device, the ADIs 206a-206b may provide backend resources 218 that include command queues and completion queues associated with a storage namespace. As yet another example, if the device 205 is a graphics processing unit (GPU), the ADIs 206a-206b may provide backend resources 218 that include dynamically created graphics or compute contexts, among other example devices and ADIs.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs). Doing so enables sharing of the device 205 across multiple processes while providing each process a complete virtual address space.

In some implementations, software 204 may implement a VDCM. In some instances, a distinct instance of software 204 (or a VDCM) may be provided for each device which is to be virtualized. For instance, a VDCM may be implemented as a device-specific component responsible for composing and implementing VDEV instances 222 using one or more ADIs allocated, for instance, by a host driver 220. The VDCM implements software-based virtualization of intercepted-path operations and arranges for direct-path operations to be submitted directly to the backing ADIs. The host driver 220 may be loaded DCMs may be implemented and packaged by device vendors in a various ways, such as user-space modules or libraries that are installed as part of the host driver or a. In other implementations, the VDCM may be a kernel module. If implemented as a library, the VDCM may be statically or dynamically linked with the hypervisor-specific virtual machine resource manager responsible for creating and managing VM resources. If implemented in the host kernel, the VDCM can be part of the host driver. The host driver is loaded and executed as part of the host OS or hypervisor software. The host driver may report support for SIOV (and/or SR-IOV) to system software through the driver interface. In addition to traditional device driver functionality, the host driver 220 may implement software interfaces (e.g., as defined by the host OS or hypervisor infrastructure) to support enumeration, configuration, instantiation, and management of ADIs. The host driver may be responsible for configuring the ADIs, including aspects such as PASID identity, Interrupt Message Storage entries, MMIO register resources for direct-path access to the ADI, and any device-specific resources, among other example functionality and features. An SIOV compatible guest driver 210 may manage the VDEV instances composed by the VDCM. Direct-path accesses by the guest driver 210 may be issued directly to the ADIs (e.g., 206a-b) mapped to the VDEV, while intercepted-path accesses are intercepted and virtualized by the VDCM (e.g., 204). In some implementations, guest and host drivers can be implemented as a unified driver that supports both host and guest functionality or as two separate drivers. For existing SR-IOV devices, if the VDEV can be composed to behave like an existing VF, the Intel Scalable IOV guest driver can be same as the SR-IOV VF driver, among other examples.

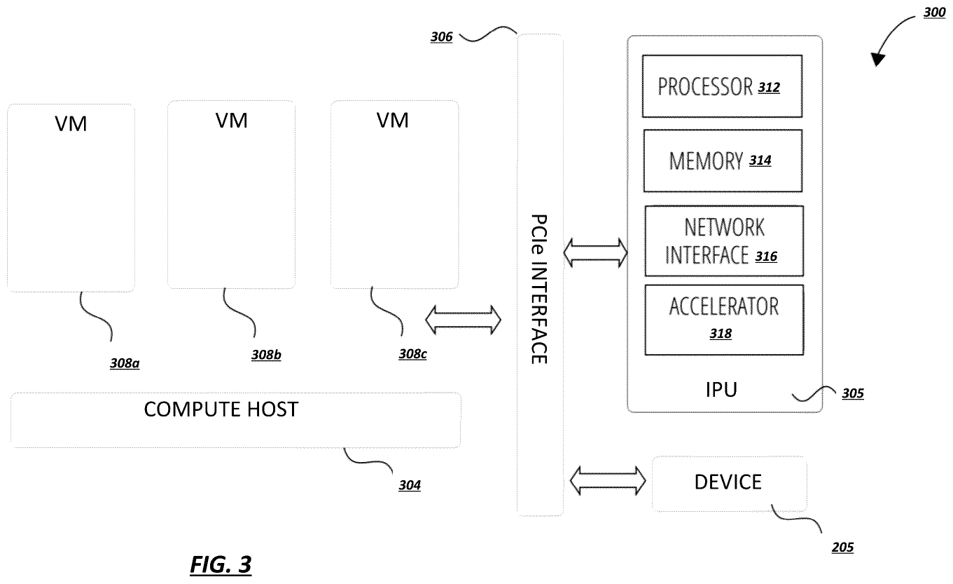

Turning to FIG. 3, a simplified block diagram 300 is shown illustrating an example network interface device 305, such as an infrastructure processing unit (IPU), smart network interface controller (smart NIC), or other networking device posing networking interfaces, networking circuitry, memory, and microcontroller (e.g., CPU). In this example, a network interface device 305 is coupled to host hardware 304, and a device 205 coupled via a PCIe interface 306. The network interface device 305, host hardware 104, device 205, and PCIe interface 306 may be implemented in circuitry. For example, the network interface device 305, host hardware 304, device 205, and PCIE interface 306 may be communicably coupled components of a compute node, server blade, server rack, or any other computing hardware. The host hardware 304 includes at least one processor circuit and memory (each not pictured). network interface device 305 also includes at least one processor 312, memory 314, an accelerator 318, and a network interface device 316 (e.g., a wired and/or wireless Ethernet network interface). The network interface device 316 may provide an interface to other devices via a network (e.g., a local area network (LAN), a wide area network (WAN), the Internet, etc.) and may support the Institute of Electrical and Electronics Engineers (IEEE) suite of Ethernet standards (e.g., 802.1, 802.3, etc.). The device 205 may be any type of peripheral device, such as a PCIe-compatible device. Although the PCIe interface 306 is used as a reference example of an interface, other interfaces may be used in the operating environment. For example, a Compute Express Link® (CXL) interface, a peripheral component interconnect (PCI), interface, a universal serial bus (USB) interface, a serial peripheral interconnect (SPI), an integrated interconnect (I2C), or a Universal Chiplet Interconnect Express (UCIe) interface may be used instead of the PCIe interface 306, among other examples. Therefore the device 205 may be a USB device, PCI device, PCIe device, CXL device, UCIe device, I2C, and/or an SPI device and provide I/O resources (e.g., for virtualization) in accordance with its corresponding I/O protocol or technology. The network interface device 305 further includes a direct memory access (DMA) engine to facilitate DMA transactions, among other example features.

The host hardware 304 may be representative of one or more processors and memory to execute one or more virtual machines (VMs), such as VM 308a, VM 308b, and VM 308c (or other containers or other isolated domains). The network interface device 305 includes one or more programmable or fixed function processors to perform offload of operations that could have been performed by processors of the host hardware 304. The network interface device 305 may therefore be considered as an “offload device.” More generally, the network interface device 305 may perform virtual switch operations, manage storage transactions (e.g., compression, cryptography, virtualization), and manage operations performed on other IPUs, compute nodes, servers, and/or devices. Indeed, an improved network interface device 305 may include SIOV and SR-IOV logic to allow SIOV functionality to be offloaded from the host to the network interface device 305 (e.g., the VDCM or other ADI management logic).

An example network interface device 305 may handle I/O, initialization, manage resources, implement security, error handling, quality of service (QoS) handling, and control. Conventionally, I/O, resources, security, and control may be performed by the host hardware 304. These functions include virtualization of devices, such as the device 205. The device 205 is representative of any type of device, such as a network interface device, accelerator device, storage device, and the like. Although depicted as external to the network interface device 305, in some embodiments, the device 205 may be a component of the network interface device 305. Similarly, although depicted as external to the host hardware 304, in some embodiments, the device 205 is a component of the host hardware 304, among other example implementations. In some implementations, the network interface device 305 may include I/O virtualization logic (implemented in hardware and/or software) to virtual aspects of the device 205. For instance, the device 205 may be virtualized by the network interface device 305 for the VMs 308a-308c based on the SIOV architecture. Similarly, the accelerator 318, network interface device 316, and other components (and device functions) of the network interface device 305 may be virtualized using the S-IOV architecture (e.g., with the device 205, network interface device 316, and the accelerator 318 being SIOV-compliant or compatible).

By outsourcing SIOV functionality from the host (e.g., the host kernel) to a network interface device (e.g., 305), host resources may be economized, additional security may be provided (e.g., through enhanced security capabilities implemented on the network interface device), and additional features and enhancements may be provided through the network interface device 305, among other example uses and advantages. For instance, VDEVs may be facilitated that includes multiple physical functions with the multiple physical functions may be provided by one or more devices 205 and/or components of the network interface device 305. Additionally, the network interface device 305 may also support SR-IOV and include SR-IOV-based physical functions and virtual functions. In some implementations, by provisioning the network interface device with SIOV logic (e.g., an I/O virtualization manager, ADI manager, VDCM, etc.), SR-IOV resources and functions may be mapped to SIOV ADIs to backport SIOV functionality to SR-IOV devices and functions, among other example applications.

SR-IOV has served as a primarily hardware-implemented standard that enables a PCIe device, such as a network interface card (NIC), to present itself as multiple virtual NICs to a hypervisor. This capability is particularly beneficial for efficiently allocating PCIe devices, including widely used Ethernet devices, among virtual machines (VMs) in cloud service systems. While SIOV offers an alternative, software-enhanced I/O virtualization scheme, SR-IOV is much more widely deployed and adopted. Moreover, for VM-level usage, even when utilizing a virtual I/O Memory Management Unit (vIOMMU), SR-IOV remains a crucial option if the VM kernel rather than an application accesses the device directly (e.g., due to SR-IOV's relative simplicity and slightly better performance (e.g., without the need for a Process Address Space ID (PASID) header in each packet). It would be beneficial, therefore, to enable some of the additional functionality (e.g., address translation, live migration, etc.) and finer-grained virtualization provided through SIOV to be “ported” to SR-IOV devices in order to realize the benefits of both technologies.

As is often the case with hardware-defined features, SR-IOV is expensive to build and difficult to upgrade. This may be particular challenging as cloud infrastructure continues to evolve, with additional high-value features being developed and desired by cloud providers and customers. As an example, advancements in address translation (e.g., to improve the performance for PCIe address translation) have occurred, which may not be supported by some SR-IOV devices. so quickly and lots of new features depending on SR-IOV need to be added. One example is the ATE (Address Translation Engine) component inside intel IPU. It is a hardware design to improve the performance for PCIe address translation. To make it acceptable to open-source community and usable for general market, some design changes related to SR-IOV are needed, which are not possible for current generation of IPU to upgrade and expensive for future ones according to the hardware defined SR-IOV approach. This document will use it as an example to illustrate the problem and proposed solution.

Indeed, address translation has emerged as a key challenge for high performance PCIe devices. Adding such functionality within the hardware-defined SR-IOV paradigm may be impracticable without an update facilitated by a corresponding hardware development cycle. However, a software-based approach, such as in SIOV, may enable provisioning and updating of such address translation functionality (e.g., Address Translation Service (ATS) 2.0). Indeed, an ADI subsystem and related SIOV software-defined capabilities (e.g., in VDCM-implemented slow path software implementations) may be utilized to effectively add this functionality to a device being virtualized using SIOV. Indeed, in an improved implementation, a network interface device may be provided with SIOV logic to enable SR-IOV virtual functions (VFs) to be mapped to a new SIOV ADI type. Accordingly, these VFs may be treated as a subordinate device from which the physical function's I/O virtualization manager (e.g., VDCM) can leverage the hardware resource to compose a hybrid VDEV based on the SR-IOV device. Further, by applying software-based SIOV virtualization to an SR-IOV device, additional software-based enhancements may be applied to the SR-IOV device, such as enhanced address translation, live migration, enhanced encryption, etc.).

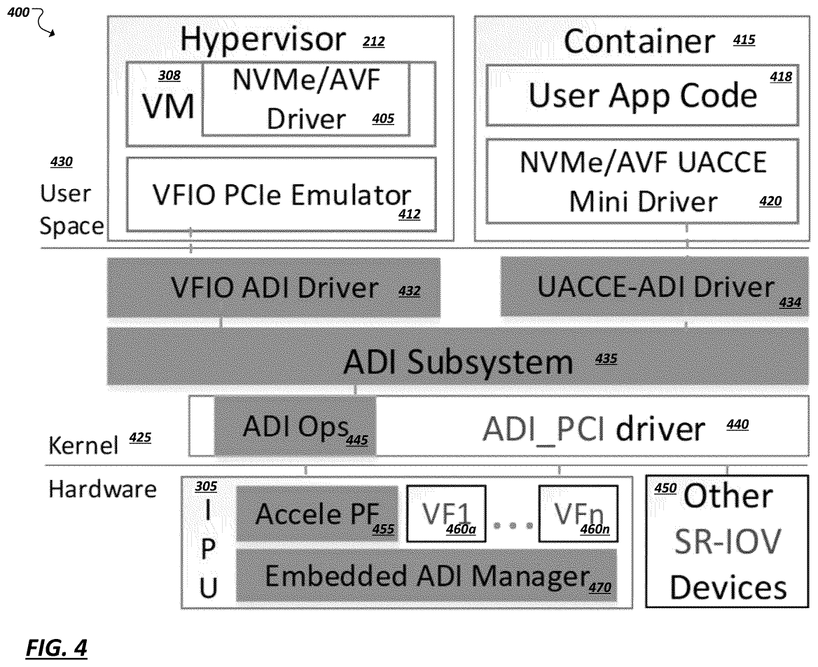

As introduced herein, an enhanced network interface device may be provided with SIOV management logic to implement a general framework to bring a “software defined” capability to SR-IOV devices, allowing the convenient and quick enhancement of such devices (e.g., to adopt the latest technologies like ATS 2.0 without the typical, lengthy hardware upgrade circle), among other example benefits. FIG. 4 is a simplified block diagram 400 showing an example operating environment for composing SIOV-based virtual devices using hybrid resources, including SR-IOV-based resources. In this example, a VMM 212 (also referred to as a hypervisor) may execute or manage a VM, such as the VM 212. The VM 308 may include a device driver 405 for a device (e.g., network interface device 305 or its constituent devices, SR-IOV device 410, etc.). The VMM 212 may further include a virtual function I/O (VFIO) PCIe emulator 412. A container 415 may execute a user application 418 and a mini driver 420. The VMM 212, VM 308, and/or the container 415 may execute on the host hardware 425 and in user space 430.

In one example, kernel space 420 may include a VFIO ADI driver 432, a UACCE ADI driver 434, an ADI subsystem 435, and a PCI driver 440 including an ADI operation 445 driver. The VFIO ADI driver 432 may correspond to a driver for a pass-through device, such as the network interface device 305 and/or the device 450. Generally, the VFIO ADI driver 432 uses a device template to compose a virtual AVF device using the mapping between the ADI and the register addresses in the ADI entry. Therefore, the VFIO ADI driver 432 preserves the attributes of the device and allows access to the device using the same driver as the corresponding host driver. The Unified/User-space access-intended Accelerator Framework (UACCE) ADI driver 434 provides Shared Virtual Addressing (SVA) between accelerators and processes, allowing an accelerator device (e.g., the device 450 and/or an accelerator component of the IPU 305) to access any data structures in the host hardware. Because of the unified address space provided by the UACCE ADI driver 434, hardware and user space processes can share the same virtual addresses when communicating. Furthermore, the VFIO ADI driver 432 implements VFIO user space interfaces based on different ADIs. Therefore, such VFIO user space interfaces may be a standard PCIe device having a standard PCIe configuration space. The UACCE ADI driver 434 may be paired with the mini driver 420 which allows the UACCE ADI driver 434 to pass through the ADI hardware to user space via the mini driver 420.

The PCI driver 440 is representative of any PCI driver that supports virtualization, including standard drivers compliant with the PCI or PCIe specification. In one example, a PCI driver 440 may be implemented as a PCI-stub driver. An example ADI PCI driver (e.g., 440) may bind to any type of device (e.g., SIOV and SR-IOV devices). If the device has a valid PCIe “ADI Extended Capability”, the ADI subsystem will try to initialize it as an ADI primary device and read the ADI Manager profile (of an example I/O virtualization manager 470) through corresponding registers. Those devices (PFs or VFs) without “ADI Extended Capability” will be treated as subordinate devices which are provide hardware resources for the ADI manager to use in VDEVs, among other examples. The PCI driver 440 may include ADI operations (ops) 445 can provide application program interfaces (APIs) for at least one driver to plug into ADI subsystem 435. The ADI subsystem 435 may be implemented as a kernel-space component associated with and cooperating with embedded I/O virtualization manager 470 of the network interface device 305. The ADI subsystem 435 may be used to identify various VDEVs and assignments of VDEVs to various isolated domains (e.g., VM 308, container 415, etc.). As noted above, the embedded I/O virtualization manager 470 of the network interface device 305 may be implemented as a VDCM, as an embedded application (or other executable code) on the network interface device 305 that is configured to compose VDEVs and emulate intercepted path operations involving the VDEVs. Generally, resources accessed through a VDEV may include resources such as control registers, status registers, BAR registers, one or more interrupt message stores (IMS), and message-signaled interrupts (MSI-X) of the underlying physical (and virtual) function(s), among other examples.

Generally, to compose a VDEV, the embedded I/O virtualization manager 470 may determine information associated with a given device function, such as PCI Base Address Register (BAR) ranges of the associated device. In some cases, the function may be a function of a device provided on the network interface device 305 itself (as one of its internal components (e.g., LAN block, accelerator blocks, etc.), and the embedded I/O virtualization manager 470 may read the information (e.g., the BAR ranges and any associated values) directly from the devices (e.g., in one or more registers) using internal interconnections (e.g., PCIe interconnections, peer-to-peer PCIe translations, DMA, etc.). In embodiments where the device function is associated with a device other than the network interface device 305 (e.g., SR-IOV device 450), the embedded I/O virtualization manager 470 may access the registers of the other device via peer-to-peer, inter-device communications (e.g., peer-to-peer PCIe translations, DMA, etc.). In some embodiments, the embedded I/O virtualization manager 470 may include a cloud agent for use in querying and receiving device function information from external (e.g., cloud-based) sources, among other examples.

Once the embedded I/O virtualization manager 470 receives the information for each device function that is to be leveraged in the desired VDEV, the I/O virtualization manager 470 may compose the corresponding VDEV using ADIs defined for one or more of the device functions. For example, the VDEV may include one or more ADIs, where each ADI may include a mapping between virtualized registers and the BARs of the underlying hardware. After the registers of the respective device function(s) are created into a corresponding ADI entry (e.g., and passed to the ADI OPs 445 of the PCI driver 440), the registers may be used as MMIO host physical addresses by software. The host or VMM may identify when operations involving a VDEV (and an associated isolated domain) constitute a direct access or intercepted access and may cause intercepted accesses to be routed to the network interface device 305 for handling by the I/O virtualization manager 470.

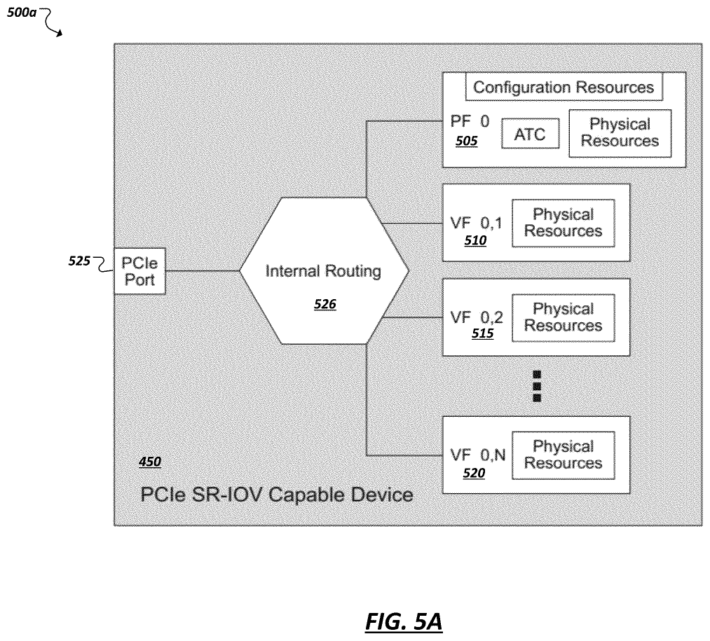

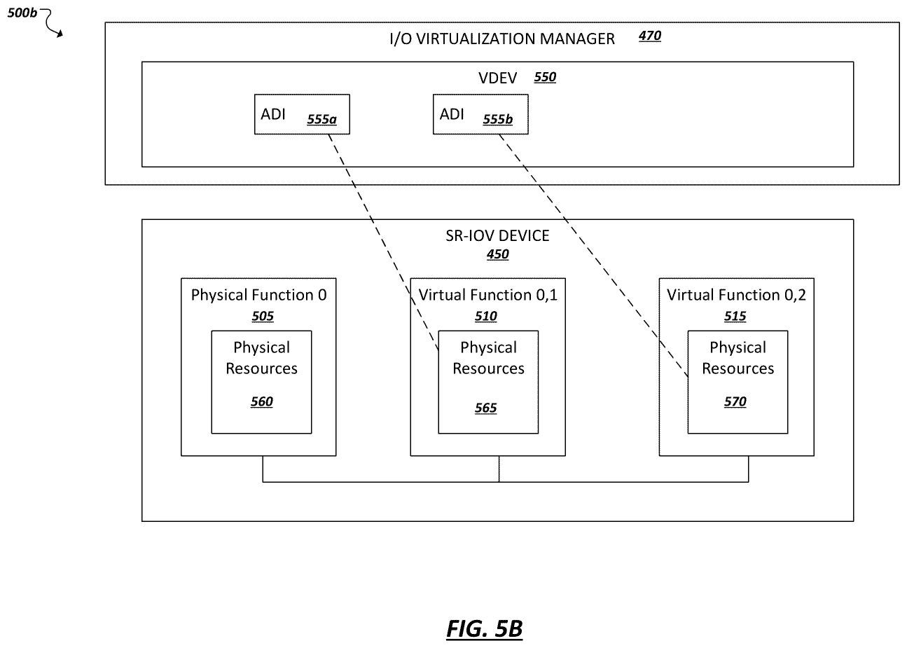

As introduced above, SR-IOV devices (e.g., 450) may be natively configured to be compatible with SR-IOV, hardware-based I/O virtualization. Such devices, whether connected to a network interface device 305 enhanced with an embedded I/O virtualization manager 470 or internal to the network interface device 305 itself, may benefit from the I/O virtualization manager's functionality to enable the SR-IOV-based virtual functions (e.g., 460a-460n) of the device to be assigned to SIOV-based ADIs and be included within SIOV-based VDEVs for use within an SIOV operating environment. This may allow legacy SR-IOV devices to be enhanced with features of SIOV and other features, which may be defined in software and emulated using the I/O virtualization manager 470. FIG. 5A is a simplified block diagram 500a showing an example SR-IOV device 450. A SR-IOV device (e.g., 450) may include one or more physical functions (PFs), with a PF (e.g., 505) having one or more (likely multiple) virtual functions (VF) (e.g., 510, 515, 520) associated with the PF 505. PFs are device functions (e.g., PCIe Functions) that support SR-IOV Extended Capability and VFs may be “lightweight” versions of the same function that may be directly accessible by an isolated domain (e.g., a container or VM). The VF may include its own resources (e.g., control registers, status registers, BAR registers, one or more interrupt message stores (IMS), and message-signaled interrupts (MSI-X)) associated with the main data movement of the function and these resources may be made available to an isolated domain that is assigned to the VF. A VF may be serially shared by different isolated domains (e.g., first assigned to one VM, then reset and assigned to a different VM, etc.). A VF associated with a respective PF has the same device type as the PF (e.g., the same network device type, same storage device type, same encryption device type, etc.). The SR-IOV device 450 shares common PCIe Link 525 (among the PF and VFs (e.g., using internal routing circuitry 526)). The Link and PCIe functionality shared by all Functions on the device 450 may be managed through Physical Function 0 (e.g., 505). A PCIe Function has a set of unique physical resources including a separate configuration space and BAR. A VF, however, shares some other resources with its associated PF, such as sharing a number of common configuration space fields with the PF, using the same configuration mechanisms and header types as a PF, etc. The associated SR-IOV extended capability register may be programmed to define the or identify the maximum number of VFs that can be associated with a given PF on the device 450. Each Function, PF, and VF may be assigned a unique Routing ID. The Routing ID for each VF may be defined using the Routing ID of its associated PF and fields in that PF's SR-IOV Extended Capability. The non-shared set of physical resources of a VF are resources used to deliver Function-specific services, (e.g., resources such as work queues, data buffers, etc.) to the isolated domain assigned. In some cases, a single address translation cache (ATC) (e.g., 530). While the example illustrated in FIG. 5A shows a single PF with multiple associated VFs, it should be appreciated that other SR-IOV devices may include multiple different PFs (of different device types), each with their own corresponding set of VFs, among other examples.

Turning to the simplified block diagram 500b of FIG. 5B, an example embedded I/O virtualization manager 470 is shown including the definition of an example VDEV 550 supported by the I/O virtualization manager 470. For instance, an example VDEV 550 includes ADIs 555a and 555b. The ADIs 555a-b may be similar to the ADIs 206a-206b. However, in this example, rather than being mapped to SIOV-based PFs, ADIs 555a-b may be mapped to one or more resources (e.g., 565, 570) of the VFs (e.g., 510, 515) of an SR-IOV device (e.g., all or a subset of the resources of a given VF) associated with an SR-IOV-based PF 505 (and using virtualizations of its physical resources 560). Each of the ADIs 555a-b may be mapped to respective backend physical resources (e.g., 565, 570) of the corresponding VFs 510, 515. For instance, when an ADI is created, a mapping between a virtual register and a physical register is created (and/or a mapping between a virtual register and an emulated register). The I/O virtualization manager 470 may compose the VDEV 550 using one or more of the ADIs 555a-b associated with VFs 510, 515. In some implementations, a network interface device having an embedded I/O virtualization manager 470 may enable VDEV definition and emulation involving VFs of multiple different SR-IOV devices coupled to or integrated in the network interface device (e.g., to form “hybrid” VDEVs based on these SR-IOV devices), among other examples. Moreover, features not native to the SR-IOV device hardware may be effectively added to the VFs of the device through emulation by the I/O virtualization manager 470 (e.g., during intercepted operations), such as advanced address translation, live migration, enhanced security, among other examples.

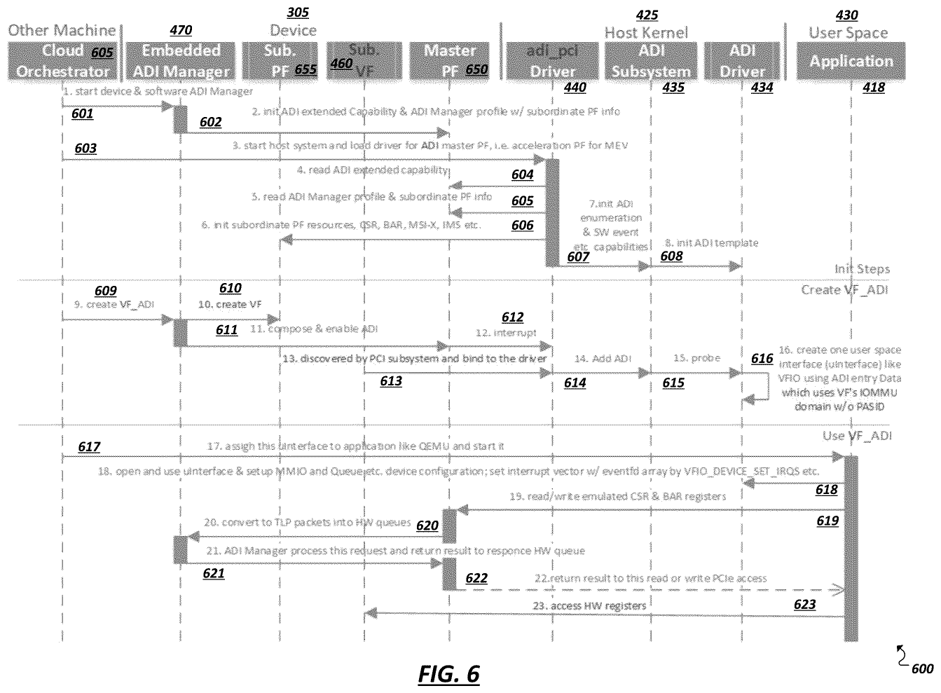

Turning to FIG. 6, an example flow diagram 600 is shown illustrating an example general approach for composing virtual devices using SR-IOV-based VFs of one or more physical devices. Generally, in the timing diagram 600, items 601-608 may correspond to system initialization steps, 609-616 may correspond to ADI creation, and items 615-326 may correspond to using the ADI, where items 617-622 corresponding to software-intercepted and/or emulated registers. Embodiments are not limited in these contexts.

As shown, at 601, cloud orchestrator software executing on a cloud system may start the system including the host hardware, a network interface device 305 hosting an embedded I/O virtualization manager 470, and one or more devices, which may include PFs and corresponding VFs. At 602, the I/O virtualization manager (e.g., a VDCM) can initialize an ADI extended capability structure and may further cause a primary physical function (e.g., 650) to be initialized, which implements at least a portion of the I/O virtualization framework (e.g., the VDCM). At 603, the host system may load a driver 440 (e.g., a PCIe driver) in the host kernel 425 for the primary PF 650, which enables an interface between an ADI subsystem 435 (corresponding to the virtualization manager 470) running in the host kernel 425 and the I/O virtualization manager 470 executing on the network interface device 305. For example, primary PF 650 may be an accelerator device (e.g., a virtualization (e.g., SIOV-based) accelerator) on the network interface device and the PCI driver 440 may correspond to this accelerator device. At 604, the driver 440 may read a register (e.g., an ADI extended capabilities structure) of the network interface device (e.g., associated with the primary PF 650) to identify (at 605) one or more VFs or another subordinate PF as well as profile information for the I/O virtualization manager. While the primary PF 650 is implemented on the same device 305 (e.g., an IPU) hosting the embedded I/O virtualization manager 470), subordinate PFs (e.g., 655) and their virtual functions (implementing subordinate VFs), may be hosted on other, separate devices (e.g., connected to the network interface device 305). The driver 440, at 606, may initialize resources of one or more of the VFs (e.g., associated with a subordinate PF 655 on the device 305 or another SR-IOV device), such as control registers, status registers, BAR registers, one or more interrupt message stores, and one or more message-signaled interrupts. At 607, the driver 440 may initialize the ADI subsystem 435 in host kernel 425 to enumerate capabilities associated with a particular ADI (e.g., mapped to all or a subset of resources of a particular VF on or connected to the network interface device) that can be used by a container or VM in user space of the host system. For example, enumerated capabilities can include virtual devices or ADI entries. Doing so may cause one or more ADIs, such as ADIs to be created in the ADI subsystem 435. At 608, the driver 440 may cause the ADI driver 434 (e.g., the VFIO ADI driver and/or the UACCE ADI driver) to initialize the ADI template for the ADI(s) created at 607. Generally, 605-608 may be performed for each subordinate PF or VF identified at 604.

At 609, the cloud orchestrator software 605 may instruct the I/O virtualization manager 470 to create an ADI. In this example, the ADI may correspond to a SR-IOV-based VF and the I/O virtualization manager 470, at 610, may cause the VF to be initialized (e.g., based on an SR-IOV protocol and using the corresponding PF of the device (e.g., a device integrated with the network interface device or another SR-IOV device coupled to the network interface device, etc.). For instance, in the SR-IOV context, a subordinate PF (e.g., 655) (e.g., in response to a prompt from the I/O virtualization manager 470) may create corresponding subordinate VF(s) (e.g., 460) associated with its resources by writing to registers in a PCIe extended capability structure corresponding to an SR-IOV Extended Capability, among other examples. The I/O virtualization manager 470 may then compose and enable the ADI (at 611) corresponding to the VF. At 612, the primary PF 650 may generate an interrupt that is transmitted to the driver 440. At 613, the VF 460 signals the driver 440 to enable discovery of the VF and bind the VF to the driver 440. At 614, the driver 440 adds the VF-based ADI to the ADI repository of the I/O virtualization manager 470. Doing so creates an entry for the ADI in the repository, where the entry includes the register mappings and any other information describing the ADI. At 615, the ADI subsystem 435 issues a probe to the ADI driver 434 (e.g., VFIO ADI driver and/or the UACCE ADI driver) to indicate that a virtual device is available to utilize. At 616, the corresponding ADI driver 434 may create a user space interface using the data in the ADI repository entry associated with the ADI. An example user space interface is a VFIO interface. However, the application 418 may not be able to use the ADI directly. Instead, the application 418 may access the ADI using the user space interface (e.g., the VFIO interface), among other example implementations. In cases of a VF-based ADI, the VF's IOMMU domain may be utilized instead of the PASID IOMMU domain, which is typically used, as the IOMMU domain of SR-IOV devices is different from that adopted and otherwise defined for SIOV, among other example features.

At 617, the cloud orchestrator 605 may assign the user space interface created at 616 to an application such as application 418 and starts the user space interface. At 618, the application 418 may open and use the user space interface. The application 418 may further set up any MMIO and/or queues. The application 418 may further configure the device implementing the VF. For example, the application 418 may set an interrupt vector by VFIO_DEVICE_SET_IRQS. At 619, the application 418 (e.g., for an intercepted path transaction) may read from and/or write to emulated control status registers (CSRs) and/or BAR registers (e.g., of the primary PF 650). For example, the application 418 may issue a request to read the emulated CSRs and/or BAR registers of the primary PF 650 (e.g., as emulated by the I/O virtualization manager 470 to correspond to the VDEV which is based on the subordinate VF 460 and includes any software-emulated enhanced features (e.g., address translation, encryption or other enhanced security features, live migration, etc.) facilitated through these emulated registers). At 620, the primary PF 620 may convert the request to one or more translation layer packets (TLPs) in one or more hardware queues of the I/O virtualization manager 470. At 621, the I/O virtualization manager 470 processes the request and returns the result to a hardware response queue of the primary PF 650. For example, the I/O virtualization manager 470 may read the emulated CSRs and/or BAR registers of the primary PF 650 and store the resulting data in the hardware response queue. At 622, the primary PF 650 returns the result of the request to the application 418. For example, the primary PF 650 may return the data read from the emulated CSRs and/or bar registers of the primary PF 650 to the application 418. At 623, the application 418 may access one or more hardware registers of the VF 460 (e.g., in a direct path transaction). For example, the application may read from and/or write to one or more hardware registers of the device implementing the VF 460.

Therefore, as shown at 623 in FIG. 6, if the application 312 requests to access hardware registers, the application 418 may directly access the hardware registers via the VF 460. However, as shown at 619-622, if the application 418 requests to access emulated registers, the application 418 provides the request to the primary PF 650, which uses the I/O virtualization manager 470 to process the request and return a result. Advantageously, the registers of different subordinate functions are arranged such that these hardware registers can be directly accessed by the application 418. However, since multiple subordinate functions (including multiple VFs) of multiple different devices may be supported, the I/O virtualization manager 470 may distinguish these based on their respective BAR addresses. The cloud orchestrator may compose a virtual device map between the emulated registers of the VDEV and the physical registers of the associated device. Doing so informs the I/O virtualization manager 470 what virtual (or emulated) registers map to which physical registers. When an ADI is created, a mapping between a virtual register and a physical register is created (and/or a mapping between a virtual register and an emulated register).

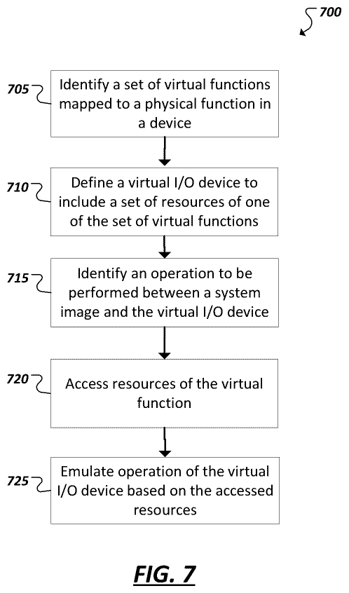

FIG. 7 is a simplified flow diagram illustrating an example technique for using an example network interface device to support I/O virtualization of one or more resources of a device supporting hardware-based I/O virtualization (e.g., SR-IOV) using software emulation of the device's resources (e.g., based on SIOV). For instance, a network interface device may be equipped with an I/O virtualization manager, which may be implemented as software or firmware code executable by a processor of the network interface device to perform software-based emulation of a virtual I/O device within a system. For instance, a set of virtual functions mapped to a physical function may be identified 705 in a device coupled to the network interface device (e.g., as a component of the network interface device or coupled to a port of the network interface device). The device may be a device compatible with an SR-IOV-based protocol. A virtual I/O device (e.g., a SIOV VDEV) may be defined 710 or generated to include one or more interfaces or references (e.g., ADIs) to resources of one or more physical devices. For instance, some of the interfaces may map to a set or subset of resources of one of the virtual functions. The virtual function may be made available for assignment to various system images, such as application running in containers or virtual machines of a host system coupled to the network interface device. Operations between a virtual device and the system image may include at least two operation types: direct path operations and intercepted path operations. In the case of direct path operations, the system image may directly access registers of the device to access resources of the virtual function. In intercepted path operations, the I/O virtualization manager of the network interface device may be forwarded an operation and may access 720 resources of the virtual function (based on the mapping of the interface within the virtual device to the virtual function resources) and may emulate 725 operation of the virtual I/O device based on the access resources, such as through the generation of a response within the operation/transaction. In some cases, the I/O virtualization manager may enhance the features of the underlying device through this emulation, for instance, to incorporate a feature not natively present or supported by the underlying device, such as an enhanced address translation scheme (e.g., ATE 2.0), live migration, enhanced security, among other examples.

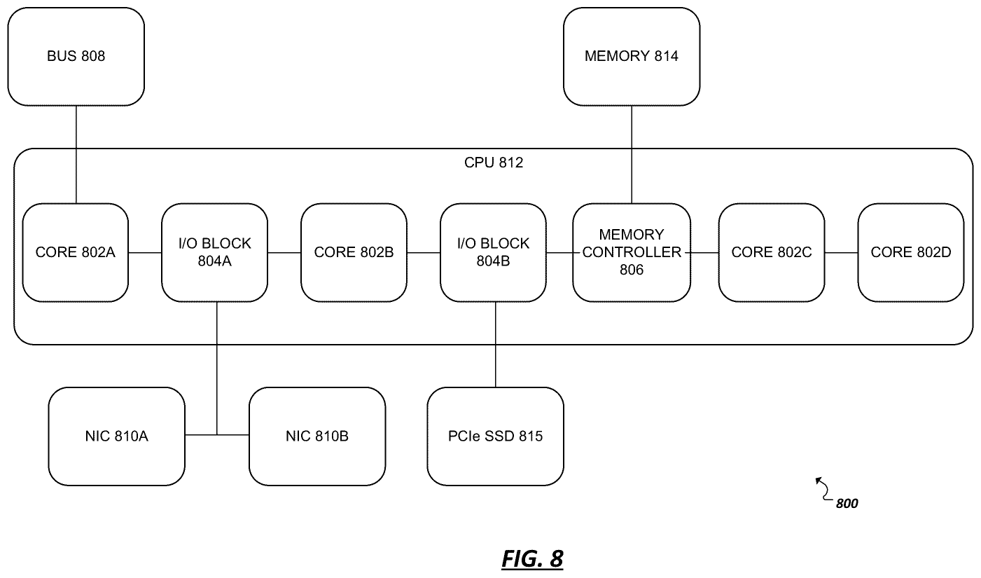

Note that the apparatus', methods', and systems described above may be implemented in any electronic device or system as aforementioned. As a specific illustration, FIG. 8 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 8, a block diagram 800 is shown of an example data processor device (e.g., a central processing unit (CPU)) 812 coupled to various other components of a platform in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores-cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a network interface device including: a processor; a first port to couple to a network; a second port to couple to a host system; circuitry to implement a physical function and support a plurality of virtual functions associated with the physical function; and an input/output (I/O) virtualization manager executable by the processor to: identify a virtual device defined to include resources of a particular one of the plurality of virtual functions; identify an operation to be performed between the virtual device and a system image hosted by the host system; and emulate the virtual device in the operation.

Example 2 includes the subject matter of example 1, where the physical function and plurality of virtual functions are based on Peripheral Component Interconnect Express (PCIe) Single Root I/O Virtualization (SR-IOV).

Example 3 includes the subject matter of example 2, where emulation of the virtual device is based on Scalable I/O Virtualization (SIOV).

Example 4 includes the subject matter of example 3, where the I/O virtualization manager includes a virtual device composition manager (VCDM).

Example 5 includes the subject matter of any one of examples 2-4, where the network interface device further includes a third port to couple to another device, the other device supports SR-IOV and supports a second physical function and a set of virtual functions associated with the second physical function, where the I/O virtualization manager is to define one or more virtual devices based on one or more of the set of virtual functions of the other device.

Example 6 includes the subject matter of example 5, where the virtual device is defined to map to both the resources of the particular virtual function of the network interface device and resources of one of the set of virtual functions of the other device.

Example 7 includes the subject matter of any one of examples 1-6, where the resources are mapped to a first assignable device interface (ADI) and the virtual device is defined to include a set of ADIs including the first ADI.

Example 8 includes the subject matter of any one of examples 1-7, where the resources include at least one of command/status registers, on-device queues, references to in-memory queues, and local memory.

Example 9 includes the subject matter of anyone of examples 1-8, where the system image is executed in an isolated domain and the isolated domain includes one of a virtual machine or a container.

Example 10 includes the subject matter of any one of examples 1-9, where the network interface device includes a local memory.

Example 11 includes the subject matter of any one of examples 1-10, where the system image directly accesses the resources of the particular virtual function in direct path operations and the system accesses the resources of the particular virtual function via emulation by the I/O virtualization manager in intercepted path operations.

Example 12 includes the subject matter of any one of examples 1-11, where the emulation of the virtual device includes emulating a feature not native to the plurality of virtual functions or the physical functions in the operation.

Example 13 includes the subject matter of example 12, where the feature includes live migration support.

Example 14 includes the subject matter of example 12, where the feature includes a particular virtual address-to-physical address translation service.

Example 15 is a non-transitory computer-readable storage medium with instructions stored thereon, the instructions executable by a processor to cause the processor to: identify, at a host system, a virtual I/O device defined by a I/O virtualization manager executed in a network interface device, where the host system is coupled to the network interface device, and the virtual I/O device is to enable access to resources of a physical device connected to or included within the network interface device; identify assignment of the virtual I/O device to a system image in an isolated domain hosted by the host system; determine that a first operation between the system image and the virtual I/O device includes a direct path operation, where the system image directly accesses the resources in the direct path operation; determine that a second operation between the system image and the virtual I/O device includes an intercepted path operation; and redirect intercepted path operations for handling by the I/O virtualization manager, where the I/O virtualization manager is to emulate operation by the virtual I/O device in software in intercepted path operations, where the resources include resources of a virtual function associated with a physical function of the physical device.

Example 16 includes the subject matter of example 15, where the virtual function is based on a Single Root I/O Virtual (SR-IOV)-based protocol and emulation of the virtual I/O device is based on a Scalable I/O Virtualization (SIOV)-based protocol.

Example 17 includes the subject matter of any one of examples 15-16, where the network interface device includes the apparatus of any one of examples 1-14.

Example 18 is a method including: defining, at a network interface device, a virtual device to include resources of a particular one of a plurality of virtual functions, where the plurality of virtual functions are associated with a physical function of a device coupled to the network interface device; identifying an operation to be performed between the virtual device and a system image hosted by a host system coupled to the network interface device; and emulating, at the network interface device, the virtual device in the operation.

Example 19 includes the subject matter of example 18, where the network interface device includes the apparatus of any one of examples 1-14.

Example 20 is a system including means to perform the method of any one of examples 18-19.

Example 21 includes the subject matter of example 20, where the means include a non-transitory storage medium with instructions stored thereon, the instructions executable by a processor to perform the method of any one of examples 18-19.

Example 22 is a system including: a host system to host a system image in an isolated domain; a first device, where the first device includes a physical function and a set of virtual functions corresponding to the physical function, where the set of virtual functions includes respective sets of resources; and a network interface device including: a processor; a memory; a first port to couple to a network; a second port to couple to the host system; a third port to couple to the first device; and an I/O virtualization manager, executable by the processor to: generate a definition of a virtual device, where the virtual device is defined to include a set of assignable device interfaces, one of the set of assignable device interfaces is mapped to at least a subset of the set of resources of one of the set virtual functions of the first device; identify an operation to be performed between the virtual device and the system image hosted by the host system; and emulate the virtual device in the operation, where the I/O virtualization manager accesses the subset of the set of resources of the virtual function to emulate the virtual device in the operation.

Example 23 includes the subject matter of example 22, where the isolated domain includes one of a virtual machine or a container.

Example 24 includes the subject matter of example 22, where the network interface device includes one of an infrastructure processing unit (IPU) or smart network interface controller (NIC).

Example 25 includes the subject matter of example 22, where the first device includes an SR-IOV-compatible device, and the first device does not natively support SIOV.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a network interface device comprising:
a processor,
a first port to couple to a network;
a second port to couple to a host system;
circuitry to implement a physical function and support a plurality of virtual functions associated with the physical function; and
an input/output (I/O) virtualization manager executable by the processor to:
identify a virtual device defined to include resources of a particular one of the plurality of virtual functions;
identify an operation to be performed between the virtual device and a system image hosted by the host system; and
emulate the virtual device in the operation.

2. The apparatus of claim 1, wherein the physical function and plurality of virtual functions are based on Peripheral Component Interconnect Express (PCIe) Single Root I/O Virtualization (SR-IOV).

3. The apparatus of claim 2, wherein emulation of the virtual device is based on Scalable I/O Virtualization (SIOV).

4. The apparatus of claim 3, wherein the I/O virtualization manager comprises a virtual device composition manager (VCDM).

5. The apparatus of claim 2, wherein the network interface device further comprises a third port to couple to another device, the other device supports SR-IOV and supports a second physical function and a set of virtual functions associated with the second physical function, wherein the I/O virtualization manager is to define one or more virtual devices based on one or more of the set of virtual functions of the other device.

6. The apparatus of claim 5, wherein the virtual device is defined to map to both the resources of the particular virtual function of the network interface device and resources of one of the set of virtual functions of the other device.

7. The apparatus of claim 1, wherein the resources are mapped to a first assignable device interface (ADI) and the virtual device is defined to include a set of ADIs including the first ADI.

8. The apparatus of claim 1, wherein the resources comprise at least one of command/status registers, on-device queues, references to in-memory queues, and local memory.

9. The apparatus of claim 1, wherein the system image is executed in an isolated domain and the isolated domain comprises one of a virtual machine or a container.

10. The apparatus of claim 1, wherein the network interface device comprises a local memory.

11. The apparatus of claim 1, wherein the system image directly accesses the resources of the particular virtual function in direct path operations and the system accesses the resources of the particular virtual function via emulation by the I/O virtualization manager in intercepted path operations.

12. The apparatus of claim 1, wherein the emulation of the virtual device comprises emulating a feature not native to the plurality of virtual functions or the physical functions in the operation.

13. The apparatus of claim 12, wherein the feature comprises live migration support.

14. The apparatus of claim 12, wherein the feature comprises a particular virtual address-to-physical address translation service.

15. A computer-readable storage medium with instructions stored thereon, the instructions executable by a processor to cause the processor to:
identify, at a host system, a virtual I/O device defined by a I/O virtualization manager executed in a network interface device, wherein the host system is coupled to the network interface device, and the virtual I/O device is to enable access to resources of a physical device connected to or included within the network interface device;
identify assignment of the virtual I/O device to a system image in an isolated domain hosted by the host system;
determine that a first operation between the system image and the virtual I/O device comprises a direct path operation, wherein the system image directly accesses the resources in the direct path operation;
determine that a second operation between the system image and the virtual I/O device comprises an intercepted path operation; and
redirect intercepted path operations for handling by the I/O virtualization manager, wherein the I/O virtualization manager is to emulate operation by the virtual I/O device in software in intercepted path operations, wherein the resources comprise resources of a virtual function associated with a physical function of the physical device.

16. The storage medium of claim 15, wherein the virtual function is based on a Single Root I/O Virtual (SR-IOV)-based protocol and emulation of the virtual I/O device is based on a Scalable I/O Virtualization (SIOV)-based protocol.

17. A system comprising:
a host system to host a system image in an isolated domain;
a first device, wherein the first device comprises a physical function and a set of virtual functions corresponding to the physical function, wherein the set of virtual functions comprises respective sets of resources; and
a network interface device comprising:
a processor,
a memory;
a first port to couple to a network;
a second port to couple to the host system;
a third port to couple to the first device; and
an I/O virtualization manager, executable by the processor to:
generate a definition of a virtual device, wherein the virtual device is defined to include a set of assignable device interfaces, one of the set of assignable device interfaces is mapped to at least a subset of the set of resources of one of the set virtual functions of the first device;
identify an operation to be performed between the virtual device and the system image hosted by the host system; and
emulate the virtual device in the operation, wherein the I/O virtualization manager accesses the subset of the set of resources of the virtual function to emulate the virtual device in the operation.

18. The system of claim 17, wherein the isolated domain comprises one of a virtual machine or a container.

19. The system of claim 17, wherein the network interface device comprises one of an infrastructure processing unit (IPU) or smart network interface controller (NIC).

20. The system of claim 17, wherein the first device comprises an SR-IOV-compatible device, and the first device does not natively support SIOV.
